(19) United States
(12) Patent Application Publication
(10) Pub. No.: US 2023/0138714 A1
(43) Pub. Date: May 4, 2023

(54) CHIP GUIDING DEVICE

(71) Applicant: Mattias BYSTRÖM, Härnösand (SE)

(72) Inventor: Mattias BYSTRÖM, Härnösand (SE)

(21) Appl. No.: 17/972,995

(22) Filed: Oct. 25, 2022

(30) Foreign Application Priority Data
Oct. 28, 2021 (SE) 2130290-6

(51) Int. Cl. B23Q 11/00; B23Q 11/08

(52) U.S. Cl. CPC B23Q 11/0046; B23Q 11/08

(57) ABSTRACT

The chip guiding device comprises a shield configured to be arranged at a rotating axis (A) of one of the machine moulder's cutter heads, such that the shield, when the machine moulder is in operation, guides the chips cut by the cutter head's cutter knives from a workpiece into a hose connected with the chip extractor. The shield may be configured to rotate together with the cutter head. The shield may be circular formed with a central hole for arranging the shield at the rotating axis (A). The shield may be provided with fan means to increase an airflow towards the hose. By providing the cutter heads of a machine moulder with chip guiding devices at the rotating axes, connected chip extractors may collect larger amounts of cut chips, and contribute to improved performance of the machine moulder.

### TECHNICAL FIELD

This disclosure relates to devices for wood processing, especially equipment for machine planers.

### BACKGROUND

When producing planks, joists, or other construction wood, logs of threes are processed in various wood processing machines. The wood will be processed into more and more refined products, such that logs are first cut in sawmills into workpieces like planks, and thereafter the workpieces are planed in machine planers, to end products of specific qualities. Both sawing and planing could be performed on fresh or dried wood, depending on what the end product shall be used for.

Machine planers or moulders are devices that could plane a workpiece and reduces its thickness. Therefore, machine planers or moulders have one or more cutter heads arranged, where the cutter heads typically act on respective sides of the workpieces. Typically, a machine moulder has multiple cutter heads arranged, while a machine planer only has one cutter head. Within this disclosure the term machine moulders will be used do denote both these machine types, i.e., it will be used in general and not be limited to a specific number of cutter heads. The workpieces are feed through the machine moulder, and the cutter heads rotate at a high speed such that cutter knives arranged at the cutter heads cut chips of wood from the workpieces' sides. Typically, the cutter head has two or more cutter knives arranged, but as the cutter head rotates at a substantially higher speed then the workpieces are fed, the planed workpiece will get a smooth surface. Different models of machine moulders have various number of cutter head arranged. In addition, as alternative to a machine moulder that merely reduces the thickness of the workpiece, there are more advanced machine planers with further cutter heads.

FIG. 1 illustrates a machine planer with three cutter heads, one for reducing the thickness of the workpiece and two for giving the workpiece specific side profiles. First, the operator feeds a workpiece and uses the thickness reduction cutter only until he or she in a couple of steps has achieved a workpiece of a wanted thickness. Subsequently, the operator uses one or both of the side cutter heads to give the workpiece's sides a specific profile. When producing matchboards, the cutter knives are selected such that one side cutter head achieves a tongue along one side, and the other cutter head achieves a groove on the other side. This type of matchboards is a common type of construction wood that could be used for building roofs or walls.

When planing, the cut wooden chips are accumulated in the machine planer and may clog the transport way through the machine. This may disturb the planer process and affect the performance of the process, and affect the quality of the end product, i.e. the resulting plank the workpiece is processed to.

To prevent that chips are accumulated in the machine planer, they are equipped with chip extractors that are fans that sucks the chips and dust into a container or bag. In addition to improving performance in processing and achieving improved quality of end products, a chip extractor will also clear the air and achieves therefore also better working conditions for the operator in the workshop.

However, it is a challenge to improve performance of machine moulders further.

### SUMMARY

It would be desirable to improve operational performance in machine moulders and planers. It is an object of this disclosure to address at least one of the issues outlined above.

Further there is an object to provide a mechanism that facilitates and makes removal of cut chips more efficient. These objects may be met by an arrangement according to the attached independent claims.

According to a first aspect, a chip guiding device for machine moulder connected to a chip extractor is provided. The chip guiding device comprises a shield configured to be releasably arranged at a rotating axis of one of the machine moulder's cutter heads, wherein the shield is circular formed with a central hole for arranging the shield at the rotating axis, such that the shield, when the machine moulder is in operation, guides the chips cut by the cutter head's cutter knives from a workpiece into a hose connected with the chip extractor, by re-directing the chips towards the hose's opening. The shield may be configured to rotate together with the cutter head. The chip guiding device may further comprise a distance unit configured to separate the shield from the cutter head at the axis. The shield may be provided with fan means to increase an airflow towards the hose. The fan means may comprise a suitable number of through-holes and flanges directed outwards extending from the axis.

The shield may comprise a plurality of flanges at the side opposite to the cutter head, and a ring formed element connecting the flanges, such that the shield increases the airflow towards the hose when rotating together with the cutter head. The shield together with the flanges and the ring formed element may form a plurality of openings distributed along the chip guiding device's circumference, such that when the shield rotates, air is sucked into a central entry of the ring formed element and blown out through the openings.

By providing the cutter heads of a machine moulder with chip guiding devices at the rotating axes, connected chip extractors may collect larger amounts of cut chips, and contribute to improved performance of the machine moulder.

### BRIEF DESCRIPTION OF DRAWINGS

The solution will now be described in more detail by means of exemplifying embodiments and with reference to the accompanying drawings, in which:

FIG. 1 is a schematic environmental illustration of machine planer in accordance with existing art.

FIG. 2 is a schematic illustration of an arrangement in a machine moulder, according to possible embodiments.

FIG. 3 is a schematic illustration of an arrangement in a machine moulder, according to possible embodiments.

FIG. 4 is a schematic illustration of an arrangement at a cutter head, according to possible embodiments.

FIGS. 5a-e are schematic illustrations of details, according to possible embodiments.

### DETAILED DESCRIPTION

In this disclosure, some exemplifying embodiments that could solve problems and improve performance of machine moulders will be described.

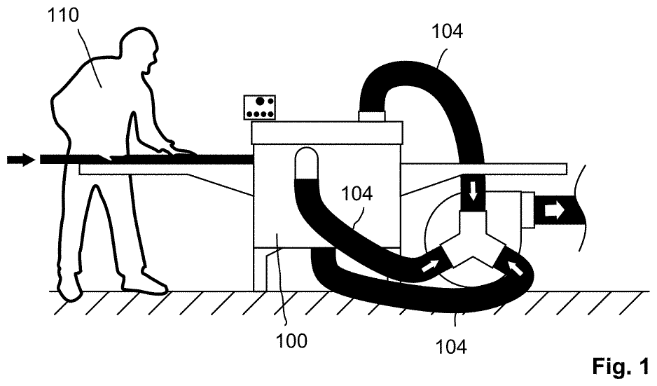

With reference to FIG. 1, which schematic illustration, a machine moulder 100 in operation will now be described in accordance with one example.

The machine moulder 100 is connected to a chip extractor 102 by a plurality of hoses 104. An operator 110 feeds a workpiece along a first table into an entry of the machine moulder 100 to process it. As will be described in more detail below in conjunction with other embodiments, the workpiece will be fed by through the machine moulder 100 and pass a plurality of rotating cutter heads, that will process the workpiece on its travel through the machine moulder 100. After being processed the moulder machine 100 outputs the workpiece at a second table, that is seen to the right in the figure.

Close to the cutter heads, chip ports (not referred to) are arranged to which respective hoses 104 are connected. The chip extractor 102 sucks the chips via the hoses 104 to bags or containers where they are collected. The chip extractor 102 will contribute to better working conditions for operators and other staff by removing chips and dust from ambient air and floors, but also to improving performance of the machine moulder 100 as chips will not block the machine moulder 100.

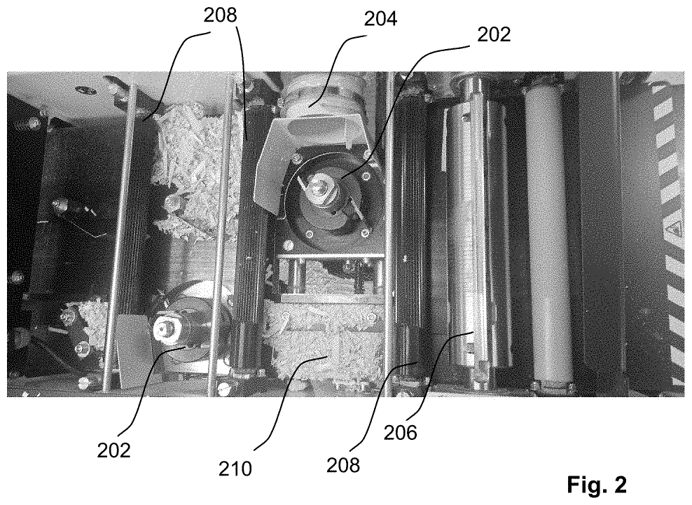

With reference to FIG. 2, which is a schematic illustration, a situation of a machine moulder will now be described in accordance with an example.

This example describes operation of a machine moulder with three cutter heads and is related to the machine moulder 100 of FIG. 1. As indicated with the white arrow, a workpiece's entry is illustrated. The machine moulder has three cutter heads 202, 206, of which two are side cutter heads 202 for giving the workpiece specific side profiles, and one is a planar cutter head 206 for reducing the workpiece's thickness. Near the side cutter heads 202, chip ports are arranged from which hoses 204 will transport cut chips away during operation. The hoses 204 connect the machine moulder to a chip extractor therefore. Even if only one chip entry is seen in FIG. 2, corresponding chip entries are typically arranged close to the other side cutter head 202 and the planar-cutter head 206. As seen in FIG. 2, even though a chip extractor is made use of, substantial amounts of chips 210 are accumulated in the machine moulder and will be an obstacle when decreasing performance of the machine moulder. For instance, accumulated chips may prevent the operator from positioning the cutter heads 202, which may affect precision of processed workpieces. Another problem with accumulated chips is that they may give rise to “chip-marks” or scratches at the workpiece's 320 surfaces. When chips get stucked between the workpiece 320 and the machine table, and the workpiece 320 is pressed against the feed table, the chip is squeezed into the workpiece 320 and destroys an already processed surface of the workpiece 320. Chips may also attach to cutter knives of the cutter heads 302 and achieve chip-marks at the workpiece's sides. A cut chip covering a cutter knife's cutting edge is typically pressed to side surface of the workpiece 320, and instead of cutting the profile with precision, a recess in the profile is achieved.

It is to be noted that the machine moulder typically comprises a plurality of further components arranged to achieve normal functionality and performance, such as e.g., various feed rollers 208 and guiding means. However, any such additional components that not directly contribute to the understanding of the inventive concept will not be further discussed in this disclosure.

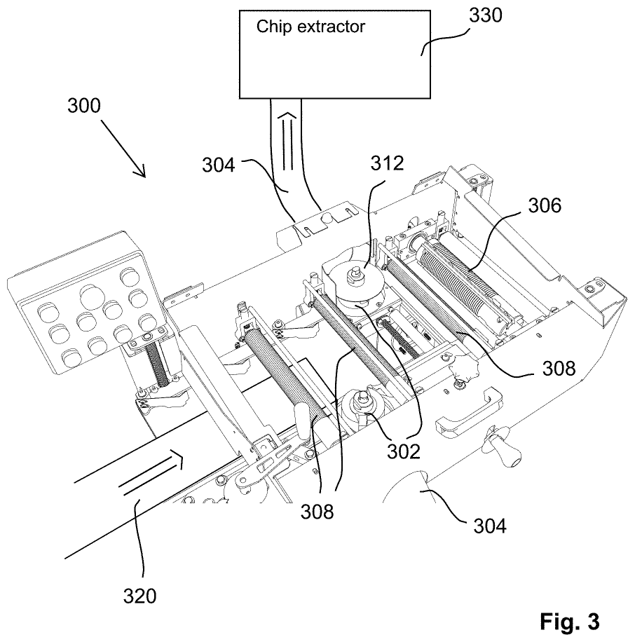

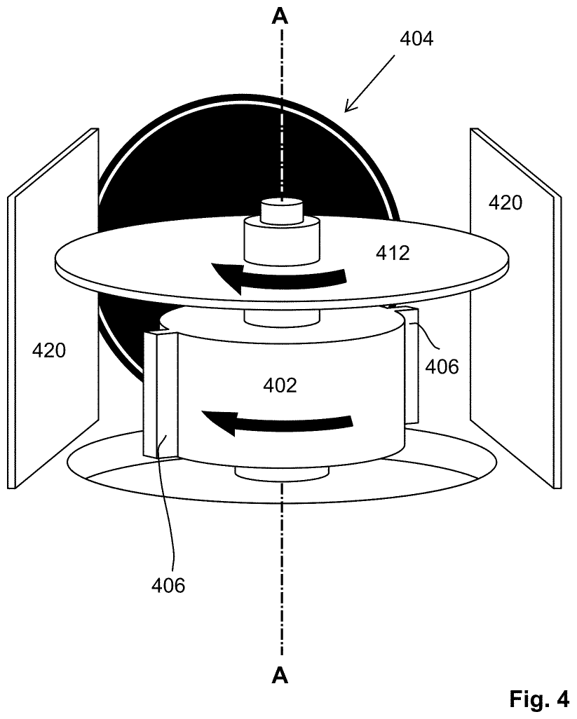

With reference to FIG. 3, which is a schematic illustration, a machine moulder 300 will now be described in accordance with exemplifying embodiments.

The machine moulder 300 is related to other machine moulders of above described embodiments. The machine moulder 300 is connected to a chip extractor 330 via hoses 304. The hoses 304 are connected to chip ports arranged close to cutter heads 302. In FIG. 3, a workpiece 320 in form of a plank is entering the machine moulder 300 and is fed by a plurality of rolls 308 through the machine moulder 300. In the end of its way through the machine moulder 300 a planar cutter head 306 processes the workpiece's 320 thickness. The machine moulder 300 may be equipped with a transparent cover, e.g. a glass lid, that is closed during the moulding process to prevent chips from being spread in the working area, but also for protecting operators from injuries by sharp cutter knives.

As the cutter heads 302 rotate fast, typically between 2000 and 8000 rpm (rounds per minute), the chips will reach a high speed and some chips will miss the chip ports and thereby be thrown into the closed area under the cover, where they will be accumulated and may decrease performance as discussed above for other embodiments.

A chip guiding device is arranged at the axis of the upper cutter head 302, in the figure and will block the chips from performing a swirling movement and be thrown into the working area. In FIG. 3, a disc-formed shield 312 of such a chip guiding device is illustrated. In order to facilitate understanding, the corresponding lower cutter head 302, in the figure is illustrated without any corresponding chip guiding device. However, normally both cutter heads 302 are equipped with chip guiding devices to achieve optimal performance. The structure and performance of the chip guiding device and its shield 312 will be further explained below in conjunction with other embodiments.

With reference to FIG. 4, which is a schematic illustration, a chip guiding device will now be described according to exemplifying embodiments.

The chip guiding device is related to chip guiding devices of above described embodiments and will here be described in more detail. A cutter head 402 is arranged at a rotating axis (A). On the cutter head 402 are two cutter knives 406 arranged, that cut chips from a workpiece fed through a machine planer. In this embodiment there are two cutter knives 406 arranged at the cutter head 402, but the inventive concept is not limited to any specific number of cutter knives 406. The cutter head 402 may have any suitable number of cutter knives 406 with appropriate cutting edges arranged when appropriate. In this embodiment, the chip guiding device comprises a shield 412 that is circular formed as a solid disc that is releasably arranged with a distance to the cutter head 402. Two optional side guides 420 are also arranged to guide cut chips towards the hose's 404 opening that is connected to the moulder machine's chip port. For achieving a distance between the shield 412 and the cutter head 402, a distance unit may be arranged, e.g., in form of a cylinder or a shaft. Alternatively, the distance is instead achieved by the form of the axis (A).

As the cutter head 402 rotates so fast, the cutter knives' 406 speed are much higher than the workpiece is feed through the moulder machines, the cut chips will be affected by and be given a swirling motion in the workspace. Therefore, even if the chip extractor establishes a sucking airstream towards the hose's 404 opening, an amount of chips will still miss the opening and be accumulated within the workspace. Typically, the swirling movement of the cut chips describes an upwards directed spiral which increasing diameter.

Dimensioning the chip extractor to increase its efficiency, requires powerful engines that consume increased amounts of electric power. Chip extractors are noisy and driving them harder increases also the noise and power consumption and affects the working conditions negatively for the operator and other staff.

By instead focusing on controlling the airstream towards the chip extractor, improved efficiency could be achieved without increasing the energy consumption. One idea is to block the up-going swirling movement of the chips, and another is to strive to achieve a lower pressure under the chip guiding device.

By arranging the shield 412 of the chip guiding device on the axis (A) above the cutter head 402 with a distance therebetween, both these ideas are realised. The shield 412 blocks the up-going swirling movement of the chips and re-directs them downwards such that they could be catched by the airstream into the hose 402 and be transported away to the chip extractor. Furthermore, as the chip guiding device with its shield 412 limits the space that the airstream acts on, the airstream about the cutter head 402 will be concentrated and stronger. I.e. the negative pressure about the cutter head will be stronger.

In this embodiment, the shield 412 of the chip guiding device is arranged on the axis (A) to rotate with the cutter head 402, without being limited thereto. Alternatively, the shield 412 may be arranged on the axis (A) to rotate at any appropriate speed, e.g., the shield 412 can be mounted at the axis (A) via a bull-bearing. The disc-formed shield 412 of this embodiment has a central hole to facilitate that it can be arranged at the axis (A).

In the figure, a pair of optional chip guides 420 are present, to further concentrate the airstream into the hose 404. Even if the cutter knives 406 primarily are arranged to process workpieces by cutting chips, in addition they also act like fan wings and feed ambient air towards the hose 404.

In an alternative embodiment, which is related to some above described ones, the chip guiding device's shield 412 is designed as a part of the cutter head 402, i.e., in one and the same unit there is a cutter head 402, a distance, and a shield 412, that will be arranged at the rotating axis (A). A benefit of that combined unit is that the operator can grab the unit in the disc-formed shield 412 with the hands when changing cutter heads 402. Thereby, except that less components have to be removed when changing tools, the operator does not have to grab the cutter head with the hands. Thus, the risk of injuries from the sharp cutter knives is reduced, and the exchange of tools will be less complex, which saves time. Compared with an ordinary guard that also covers its cutter knives, the above disclosed chip guide in addition facilitates easy change of cutting tools. By removing the releasably arranged shield 412 from the rotating axis, the operator gets convenient access directly to the cutting tool, i.e., the cutter 402. He/she may then easily change cutting tools without having to dismantle a full guard, that often is designed as a housing that is connected to a hose and covers the cutting tool.

Thereby, a convenient and flexible process in a plurality of steps could be achieved, where the operator changes cutting tools. For instance, the operator may first process the workpiece to an appropriate width before giving it the appropriate edge profile in one or several steps.

As will be further described below in conjunction with other embodiments, the chip guiding device's shield 412 may be designed to further improve its efficiency.

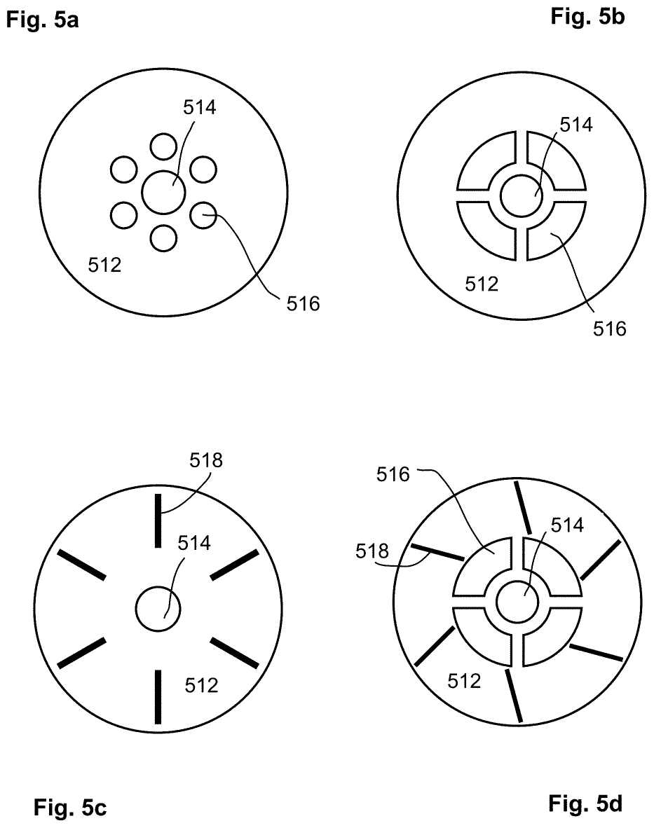

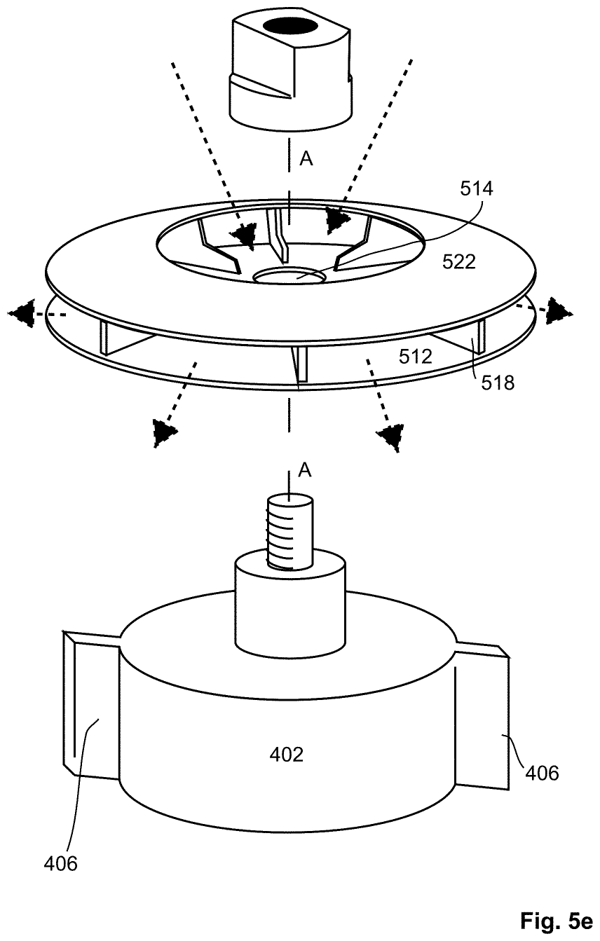

With reference to the FIGS. 5a-d, which are schematic illustrations, some alternative designs of shields of chip guiding devices will now be described in accordance with exemplifying embodiments.

The chip guiding devices' shields 512 have central holes 514 to facilitate arrangement on the rotating axis on which the cutter head is arranged. The shields 512 could be designed with further details to further achieve increased performance.

In FIG. 5a, a plurality of through-holes 516 are provided as fan means that are configured to increase airflow towards the hose and thereby the chip extractor. In FIG. 5a, the through-holes 516 are located close to the centre of the shield 512 but may be alternatively located without deviating from the inventive concept. A skilled person may design the shield 512 with any suitable number of through-holes 516, with suitable diameters and in suitable pattern for achieving appropriate performance, e.g., an appropriate airflow.

In FIG. 5b, a variant is shown where the through-holes 516 are non-circular, but instead arc-formed.

Even if through-holes 516 of various sizes and forms increase the airstream towards the hoses and the chip extractors, alternative fan means may be arranged instead of through-holes 516 or in combination with through-holes 516.

In FIG. 5c, an alternative design is illustrated, where the fan means are configured as a plurality of flanges 518. The flanges 518 are provided on the side of the shield 512 that faces the cutter head in operation.

FIG. 5d, illustrates another variant, where the fan means are provided as a combination of through-holes 516, and flanges 518. Within the inventive concept, the skilled person may design any suitable combination of through-holes 516 and flanges 518 in order to achieve optimal performance. For instance, he/she may select any suitable numbers and forms of through-holes 516 and flanges 518.

With reference to FIG. 5e, that is a schematic illustration, a chip guiding device will now be described in accordance with one exemplifying embodiment.

This embodiment is related to some above described embodiments and we will here focus on the differences and the additional performance that is achieved. The shield 512 with its central hole 514 is configured to be releasably arranged at the cutter head 402. When arranged, the shield 512 will be releasably fixated at the rotating axis A by the nut. The shield 512 is provided with outwardly directed flanges 518 and a circular element 522. The circular element 522 is designed to together with the shield 512 and the flanges 518 form: a central entry for capturing ambient air; and a plurality of openings along the chip guiding device's circumference for blowing out the captured air. The air flows are illustrated by dashed arrows in FIG. 5e.

By providing the shield 512 with flanges 518 and the circular element 522, it will additionally acquire the functionality of a fan that distributes a sheet of air over the cutter head 402. This air sheet has some beneficial functionalities, e.g., it establishes an air-curtain outside the shield 512 that re-directs cut chips; and it blows chips and dust away from the workpiece 320. The air-curtain extends the re-directing area of the shield 512, i.e., the effective guiding area of the chip guiding device increases, and the blowing air contributes to keeping the working area clean from cut chips and dust. Therefore, the fan-functionality contributes both to make the chip guiding device more efficient, and to improve precision of the resulting processed workpiece, as chip-marks efficiently will be prevented from arising.

It is to be noted that even if the shields 312, 412, 512 of the chip guiding devices of this disclosure have been illustrated as variants of circular formed discs, they are not limited thereto. A skilled person would alternatively design the shields' circumferences with any appropriate forms, e.g., to further increase the airflow towards the chip extractors.

Reference throughout the specification to “one embodiment” or “an embodiment” is used to mean that a particular feature, structure or characteristic described in connection with an embodiment is included in at least one embodiment.

Thus, the appearance of the expressions “in one embodiment” or “in an embodiment” in various places throughout the specification are not necessarily referring to the same embodiment. Further, the particular features, structures or characteristics may be combined in any suitable manner in one or several embodiments. Although the present invention has been described above with reference to specific embodiments, it is not intended to be limited to the specific form set forth herein. Rather, the invention is limited only by the accompanying claims and other embodiments than the specific above are equally possible within the scope of the appended claims. Moreover, it should be appreciated that the terms “comprise/comprises” or “include/includes”, as used herein, do not exclude the presence of other elements or steps.

Furthermore, although individual features may be included in different claims, these may possibly advantageously be combined, and the inclusion of different claims does not imply that a combination of features is not feasible and/or advantageous. In addition, singular references do not exclude a plurality. Finally, reference signs in the claims are provided merely as a clarifying example and should not be construed as limiting the scope of the claims in any way.

The scope is generally defined by the following independent claims. Exemplifying embodiments are defined by the dependent claims.

### NUMBERED EXEMPLIFYING EMBODIMENTS (NEE)

NEE1. Chip guiding device for a machine moulder (100, 300) connected to a chip extractor (330), comprising:
   a shield (312, 412, 512) configured to be arranged at a rotating axis (A) of one of the machine moulder's cutter heads (202, 302, 402), such that the shield (312, 412, 512), when the machine moulder (100, 300) is in operation, guides chips cut by the cutter head's (202, 302, 402) cutter knives (406) from a workpiece (320) into a hose (104, 204, 304, 404) connected with the chip extractor (330).
NEE2. The chip guiding device according to NEE 2, wherein the shield (312, 412, 512) is configured to rotate together with the cutter head (202, 302, 402).
NEE3. The chip guiding device according to NEE 1 or 2, wherein the shield (312, 412, 512) is circular formed with a central hole (514) for arranging the shield (312, 412, 512) at the rotating axis (A).
NEE4. The chip guiding device according to NEE 3, further comprising a distance unit configured to separate the shield (312, 412, 512) from the cutter head (202, 302, 402) at the axis (A).

NEE5. The chip guiding device according to NEE 1, wherein the shield (312, 412, 512) is provided with a fan means (516, 518) configured to increase an airflow towards the hose (104, 204, 304, 404).
NEE6. The chip guiding device according to NEE 5, wherein the fan means (516, 518) comprises at least one of:
   a plurality of through-holes (516), and
   a plurality of flanges (518) on one side of the shield (312, 412, 512), and being directed outwards extending from the axis (A)

1. Chip guiding device for a machine moulder connected to a chip extractor, comprising:
a shield configured to be releasably arranged at a rotating axis (A) of one of the machine moulder's cutter heads, wherein the shield is circular formed with a central hole for arranging the shield at the rotating axis (A), such that the shield, when the machine moulder is in operation, guides chips cut by the cutter head's cutter knives from a workpiece into a hose connected with the chip extractor, by re-directing the chips towards the hose's opening.

2. The chip guiding device according to claim 1, wherein the shield is configured to rotate together with the cutter head.

3. The chip guiding device according to claim 1, further comprising a distance unit configured to separate the shield from the cutter head at the axis (A).

4. The chip guiding device according to claim 1, wherein the shield is provided with at least one of:
a plurality of through-holes distributed around the central hole, and
a plurality of flanges arranged at a side of the shield facing the cutter head, wherein the flanges are outwards directed from the axis (A).

5. The chip guiding device according to claim 1, wherein the shield comprises:
a plurality of flanges at a side of the shield opposite the cutter head, and
a ring formed element connecting the flanges, such that the shield increases an airflow towards the hose when rotating together with the cutter head.

6. The chip guiding device according to claim 5, wherein the shield together with the flanges and the ring formed element form a plurality of openings distributed along the shield's circumference, such that when the shield rotates, air is sucked into a central entry of the ring formed element and blown out through the openings.

7. The chip guiding device according to claim 2, further comprising a distance unit configured to separate the shield from the cutter head at the axis (A).

8. The chip guiding device according to claim 4, wherein the shield comprises:
a plurality of flanges at a side of the shield opposite the cutter head, and
a ring formed element connecting the flanges, such that the shield increases an airflow towards the hose when rotating together with the cutter head.
